(19) United States
(12) Patent Application Publication
(10) Pub. No.: US 2015/0331552 A1
(43) Pub. Date: Nov. 19, 2015

(54) SYSTEM AND METHOD FOR HYPERLINK BADGES WITH DYNAMICALLY UPDATED POP-UP SUMMARY INFORMATION

(71) Applicant: SHOCASE, INC., San Francisco, CA (US)

(72) Inventors: Ronald P. YOUNG, Mill Valley, CA (US); David Anthony Burgess, Menlo Park, CA (US); Peter Rugg, New York, NY (US)

(21) Appl. No.: 14/712,684

(22) Filed: May 14, 2015

Related U.S. Application Data
(60) Provisional application No. 61/993,029, filed on May 14, 2014.

(51) Int. Cl. G06F 3/0481; G06F 3/0484

(52) U.S. Cl. CPC G06F 3/0481; G06F 3/0484

(57) ABSTRACT

Methods, systems, and media are directed to providing a pop-up display having dynamically updated summary data on a website, is presented. In particular, electronically submitting updated informational content to a third party source repository and providing a graphical item having embedding linking instructions configured to bilaterally communicate with the third party source repository and render a pop-up display containing the updated informational content. Thus, upon actuation of the graphical item, the embedded linking instructions causes establishment of bilateral communications with the third party source repository, accesses the corresponding updated informational content stored in the third party source repository, retrieves the updated informational content, and automatically displays the updated informational content in a pop-up display.

### CROSS-REFERENCE TO RELATED APPLICATIONS

This Application claims priority to U.S. Provisional Patent Appin. Ser. No. 61/993,029, filed May 14, 2014 entitled, “SYSTEM AND METHOD FOR HYPERLINK BADGES WITH DYNAMICALLY UPDATED POP-UP SUMMARY INFORMATION.”

This Application is also related to U.S. Appin. Ser. No. 14/507,003, filed Oct. 6, 2014 entitled, “SYSTEM AND METHOD TO PROVIDE COLLABORATION TAGGING FOR VERIFICATION AND VIRAL ADOPTION,” which claims priority to U.S. Provisional Patent Appin. Ser. No. 61/887,423, filed Oct. 6, 2013 entitled, “A SYSTEM AND METHOD TO PROVIDE COLLABORATION TAGGING FOR VIRAL VERIFICATION AND ADOPTION.”

### FIELD OF THE INVENTION

The present invention generally relates to aspects of social networking site platforms and, more particularly to, the automatic presentation of dynamically updated information in the form of hyperlinked pop-up displays to be used in conjunction with webpages.

### BACKGROUND OF THE INVENTION

Given their immense popularity, social networking websites have spawned in prodigious numbers across the globe. The attraction of these websites rests squarely on their ability to enable users to socially interact with other users by facilitating the sharing of user-generated content, such as, blogs, images, videos, messages, etc. Typically, users sign up with the social networking website by providing certain user information and the computer server that hosts the website provides access thereto.

These social networking sites typically employ web pages that are configured to allow users to interactively communicate with the sites. Such web pages incorporate embedded hypertext linking objects (i.e., hyperlinks) that, upon actuation (i.e., such as by clicking on the hyperlink), enables users to be redirected from one hypertext file or document to another location or file, typically activated by clicking on a highlighted word or image on the screen. In some implementations, social networking sites employ hyperlinked “pop-up” displays that convey information to the user when a computer cursor is hovered over a hyperlink hot-spot on the web page. Such hyperlinked pop-up displays may include, for example, the uniform resource locator (URL) information of the redirected webpage, a preview of the redirected webpage, a thumbnail image, a message, etc.

It will be appreciated, however, that the information presented in hyperlinked pop-up displays is static in nature as it has to be written or posted directly into the host web page. In so doing, such hyperlinked pop-up displays are incapable of automatically providing dynamically updated and relevant information to visitors.

### SUMMARY OF THE INVENTION

The invention, as disclosed herein, addresses the deficiencies and drawbacks noted above by providing systems and methods that are directed to the automatic rendering of dynamically updated information in the form of hyperlinked pop-up displays that may be used in conjunction with webpages.

Methods, systems, and media are directed to providing a pop-up display having dynamically updated summary data on a website, is presented. In particular, electronically submitting updated informational content to a third party source repository and providing a graphical item having embedding linking instructions configured to bilaterally communicate with the third party source repository and render a pop-up display containing the updated informational content. Thus, upon actuation of the graphical item, the embedded linking instructions causes establishment of bilateral communications with the third party source repository, accesses the corresponding updated informational content stored in the third party source repository, retrieves the updated informational content, and automatically displays the updated informational content in a pop-up display.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a typical web page layout containing multimedia items with corresponding embedded hyperlinks.

FIG. 2 depicts a hyperlinked pop-up display displaying static information.

FIG. 3 depicts the one-way flow of a conventional static hard-coded hyperlink.

FIG. 4 depicts a platform for the automatic presentation of updated information through dynamic hyperlinked displays to be used in conjunction with social networking sites, in accordance with various aspects of the present disclosure.

FIG. 5 depicts a hyperlinked pop-up display displaying dynamic information based on the platform provided by FIG. 4, in accordance with various aspects of the present disclosure.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

As will be apparent by the ensuing description and illustrations, the disclosed embodiments relate to the automatic rendering of dynamically updated information in the form of hyperlinked pop-up displays that may be used in conjunction with webpages.

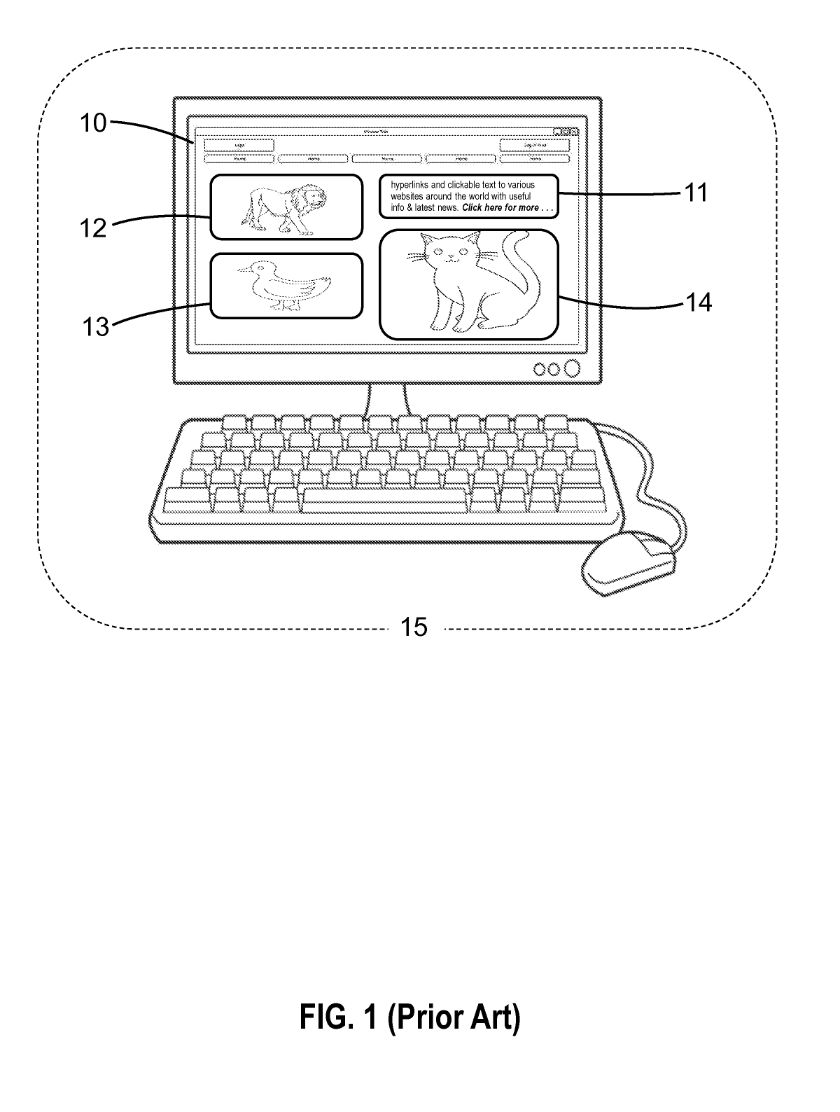

By way of review, FIG. 1 depicts a typical web page layout 10, as presented on a user communication device 15. While user communication device 15 is illustrated as a desktop computer, it will be appreciated that user communication device 15 may comprise any number of communication-enabled devices, such as, for example, a laptop, mobile device, cellular/smartphone, gaming device, tablet computer, personal communication system (PCS) device, personal digital assistant (PDA), and/or any other electronic wireless-enabled device configured to transmit and receive communications via wired or wireless networks.

The typical web page layout 10 may contain both text and multimedia images, sound, and video. As shown in FIG. 1, web page layout 10 displays various multimedia items 11-14 on user communication device 15, in which selectable information is indicated by means of text 11 or graphical images (e.g., icons or bit-mapped images) 12-14. Multimedia items 11-14 are encoded with embedded hypertext links (i.e., hyperlinks), which are configured to enable users, upon actuation (i.e., such as by clicking with a pointing device or touching on a touchscreen display a hyperlink, highlighted word, or image), to branch to, or be redirected to, another resource, such as, a web location, file, or object, based on the encoded uniform resource locator (URL) information encoded therein. The encoding may be implemented by a variety of known coding languages, such as, HTML, XML, XHTML, DHTML, PERL, etc., in which commands are encapsulated by instructional tags embedded in the webpage itself that are not visible to users.

With graphic-based hyperlinks, a user may click anywhere within the graphic's boundary box area to actuate the redirection to the corresponding destination resource (e.g., another webpage). Alternatively, graphic-based hyperlinks may be represented as an icon or “badge” that appears to be superimposed over the main webpage window containing the multimedia items which, upon clicking, redirects the user to the destination resource. In addition, certain areas of the webpage layout may be hyperlinked to form hyperlink “hotspots,” such that, upon a cursor/pointer hovering over a hotspot, a pop-up display may be displayed with an informational message.

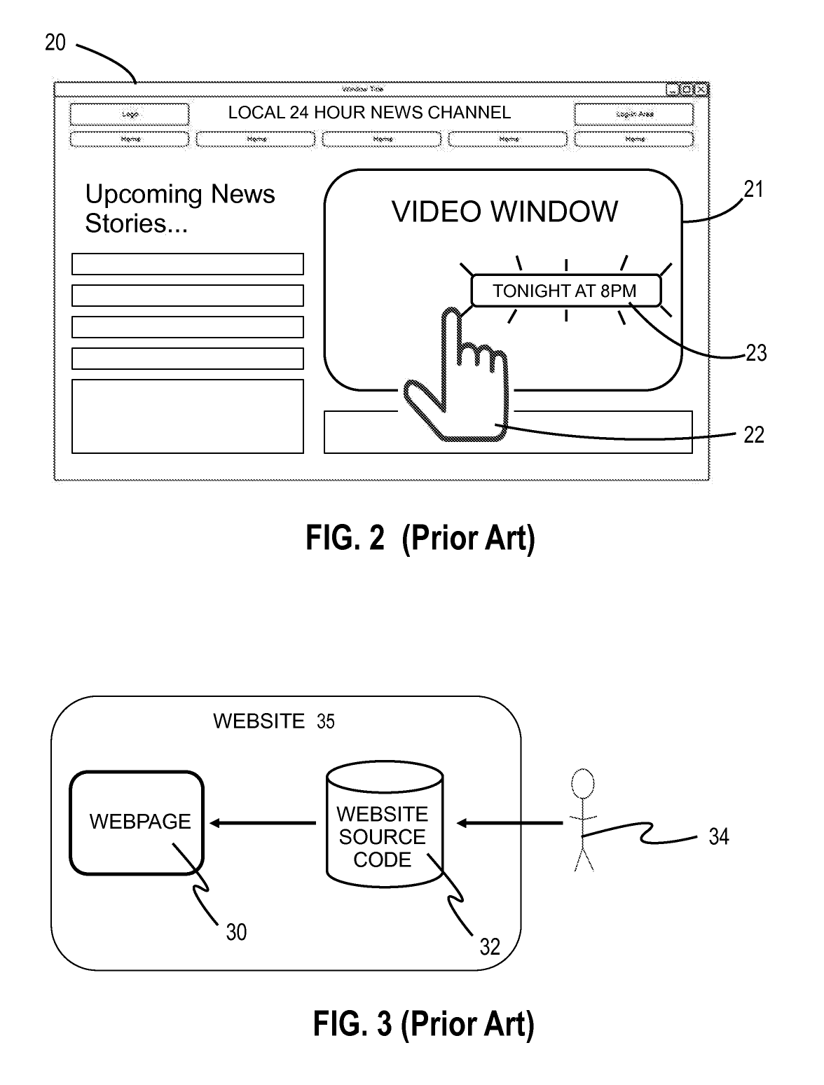

Along these lines, FIG. 2 illustrates the use of pop-up displays in a webpage for conveying information to users. In the depicted example, local news webpage 10 displays a variety of multimedia items that contain embedded hyperlinks. Among the multimedia items contained in web page 10, video item 21 is presented indicating a promotional item regarding an upcoming news feature. When the user hovers cursor 22 over video item 21, the user is presented with pop-up display 23 providing information that is relevant to video item 21.

In the conventional configuration noted above, the pop-up display informational text is limited to simple pieces of information about the content and time of broadcast, which comprises static information. This is because such information has to be hard-coded into the HTML programming governing the operations of web page 10. In other words, the only manner in which the pop-up display informational text can be updated, is by a programmer modifying the embedded code within web page 10 to update/revise the informational text presented.

Indeed, as better illustrated in FIG. 3, the underlying reason for the static nature of pop-up display information is that the embedded hyperlinks for conventional webpages are configured to operate as a one-way communication flow of information. For example, as shown in FIG. 3, web page 30 contains a hyperlink that pulls its pop-up display information from within the programmed source code 32 corresponding to website 35. Given the one-way flow of communication, the pop-up display information programmed in source code 32 can only be updated by programmer 34 re-writing/revising the web page source code 32.

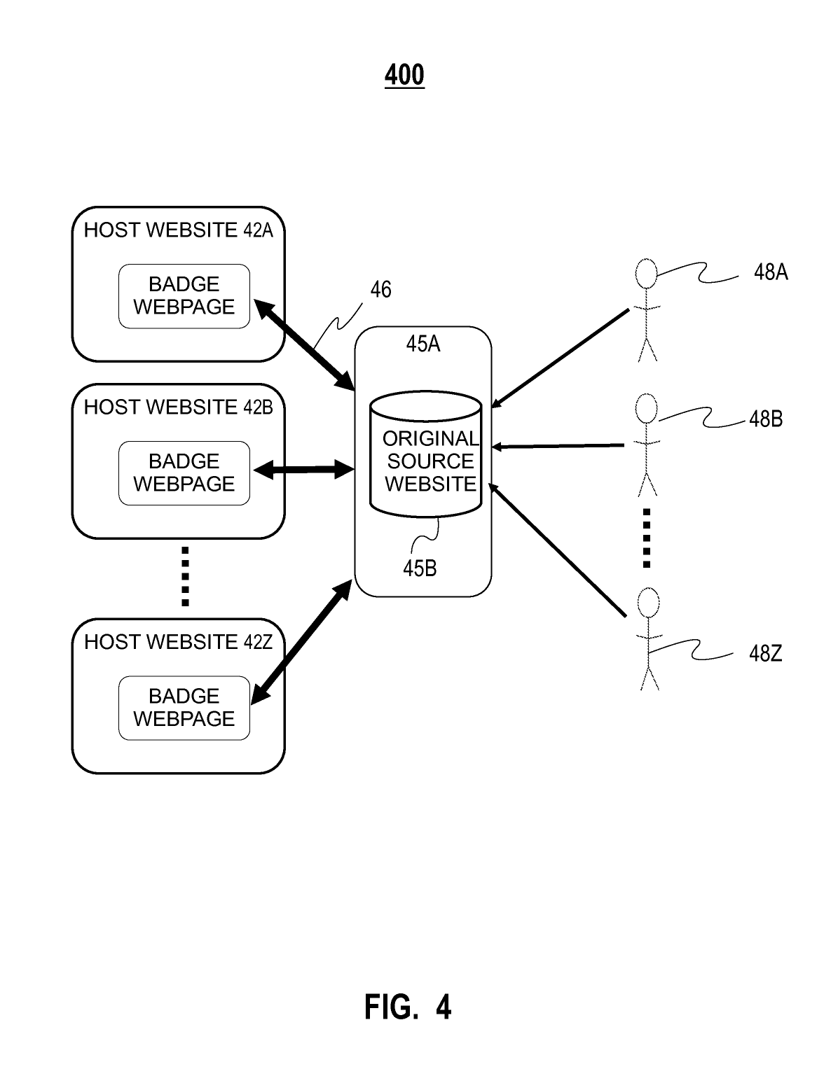

With this said, FIG. 4 depicts system 400 that provides a platform for the automatic presentation of updated information through dynamic hyperlinked displays to be used in conjunction with websites, in accordance with various aspects of the present disclosure. As depicted, the platform of system 400 comprises a plurality of host websites 42A-42Z, each of which is adapted to bilaterally communicate, either wired or wirelessly via a network transmission facility 46, with original source third party website 45A that receives and stores updated informational message content from registered members 48A-48Z.

By way of illustration, host websites 42A-42Z embody any website containing webpages with hyperlink badges configured to, upon actuation, automatically display dynamically updated informational messages via pop-up displays. The hyperlink badges may be designed to attract and invite visitors to websites 42A-42Z to hover over the badges' hotspot in order to seek the informational messages displayed by the actuated pop-up display. The badges may take the form of graphical items, icons, or annotated symbols, such as, for example, a logo of a company, and are encoded with embedded hyperlinks that, in addition to other functionality, also triggers the bilateral communication with original source third party website 45A.

In certain embodiments, original source third party website/repository 45A is configured to enable registered members 48A-48Z to electronically submit informational content, at any time, regarding any activities, promotions, notifications, etc. that members 48A-48Z desire to publicize or disclose via badge messaging. It will be appreciated that registered membership may be open to private individuals, companies, advertisers, governmental agencies, or any entity that wishes to automatically display dynamically updated informational messages via pop-up displays on websites 42A-42Z. For security/privacy reasons, registered members 48A-48Z would be granted access to their section of original source third party website 45A and allowed to submit information upon authentication of members' 48A-48Z credential information, such as, usernames, passwords, uniquely identifying member data, account numbers, etc.

Upon successful authentication and submission of member information, original source third party website 45A stores the information in the website's repositories, original source database(s) 45B, in accordance with registered members' 48A-48Z account and uniquely identifying member data. The source database(s) 45B is configured to be updated at any time with the latest information submitted by registered members 48A-48Z. The source database(s) 45B may include, or interface with, for example, an Oracle™ relational database, Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. It will be appreciated that database(s) 45B may comprise one or more such databases that reside in one or more physical devices and within one or more physical locations.

As noted above, the hyperlinked badges of host websites 42A-42Z are configured to bilaterally communicate with original source third party website 45A in order to automatically display dynamically updated informational messages via pop-up displays. Specifically, the badges are embedded with a hypertext/hyperlink code set that includes instructions to initiate communications with original source third party website 45A as well as account data identifying the informational message content corresponding to registered member 48A that is stored in in original source database(s) 45B. Consequently, the embedded code set causes the establishment of communications with original source third party website 45A, accesses the corresponding updated informational message content stored in original source database(s) 45B, retrieves the most recent informational message, and automatically displays the most recent informational message in a pop-up display.

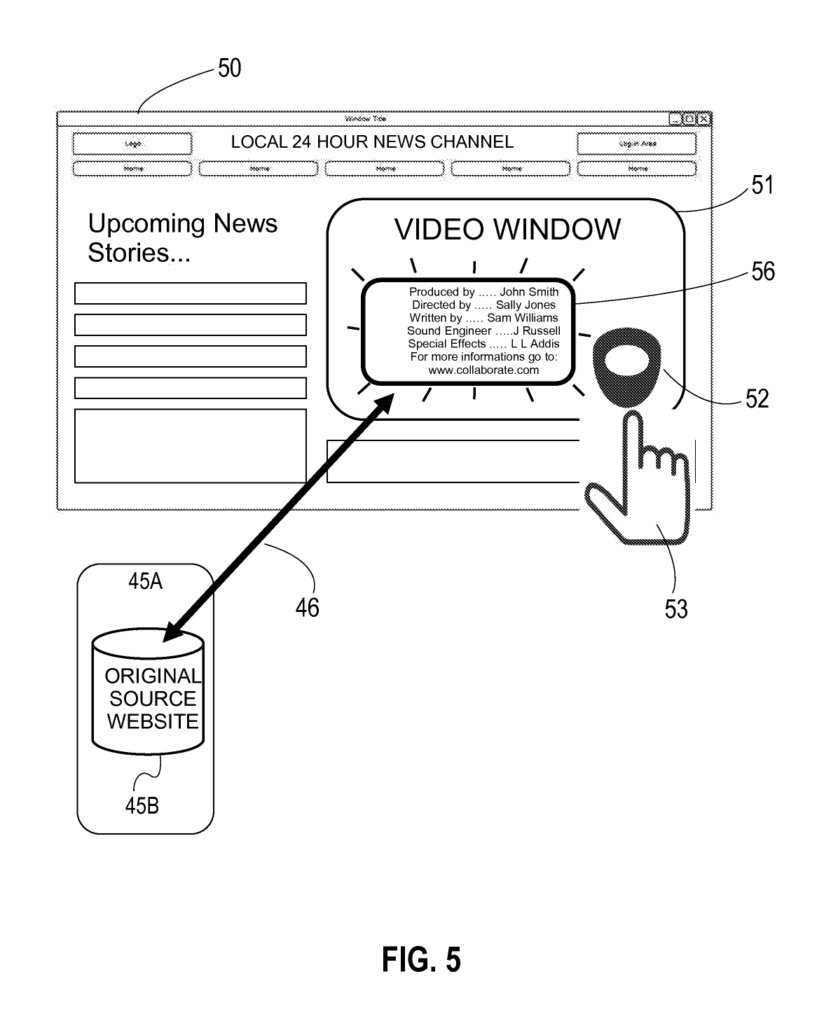

FIG. 5 illustrates the operational attributes of the system 400 platform noted above relative to webpage 50, in accordance with various aspects of the present disclosure. In the depicted embodiment, local news webpage 50 displays a variety of multimedia items that contain embedded hyperlinks. Among the multimedia items contained in web page 50, video item 51 is presented with hyperlink badge 52 indicating a promotional item regarding an upcoming news feature. As a graphical icon, hyperlink badge 52 is designed to entice visitors to hover over its hotspot area and, in accordance with the configurational features of system 400 noted above, is embedded with a predetermined hypertext/hyperlink code set. Thus, when visitors hover their cursor/pointer 53 over the hotspot of badge 52, the code set causes badge 52 to be actuated to communicate with original source third party website 45A, causes badge 52 to access and retrieve the most recent informational message content submitted by corresponding registered member 48A that is stored in original source database(s) 45B, such that visitor is automatically presented with the updated informational message in pop-up display 56. The visitor also has the option to click on the included hyperlink to be directed to the data-source website.

Thus, by virtue of the configuration of the platform of system 400, including two-way communications and instructional code sets embedded in the website badges, system 400 enables informational messages to be automatically displayed via pop-up displays. The informational messages can be updated, revised, or otherwise modified to present the most recent content provided by any corresponding registered member via the simple forwarding of updated information to original source third party website 45A -without any need to rewrite/revise/update the actual webpage source code at host websites 42A-42Z.

It should be appreciated that other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of providing a pop-up display having dynamically updated summary data on a website, comprising:
electronically submitting updated informational content to a third party source repository; and
providing a graphical item having embedding linking instructions configured to bilaterally communicate with the third party source repository and render a pop-up display containing the updated informational content;
wherein, upon actuation of the graphical item, the embedded linking instructions causes establishment of bilateral communications with the third party source repository, accesses the corresponding updated informational content stored in the third party source repository, retrieves the updated informational content, and automatically displays the updated informational content in a pop-up display.
